(19) United States
(12) Patent Application Publication
(10) Pub. No.: US 2026/0142532 A1
(43) Pub. Date: May 21, 2026

(54) MOTOR COOLING SYSTEM

(71) Applicants: Hyundai Motor Company, Seoul (KR); Kia Corporation, Seoul (KR)

(72) Inventors: Jung Ho HA, Hwaseong-si (KR); Sun Gyu PARK, Hwaseong-si (KR); Han Sang KIM, Hwaseong-si (KR); Kyung Keun SUH, Hwaseong-si (KR); Hyeong Seok LEE, Hwaseong-si (KR)

(73) Assignees: Hyundai Motor Company, Seoul (KR); Kia Corporation, Seoul (KR)

(21) Appl. No.: 19/228,420

(22) Filed: Jun. 4, 2025

(30) Foreign Application Priority Data
Nov. 19, 2024 (KR) 10-2024-0165581

(51) Int. Cl. H02K 9/19

(52) U.S. Cl. CPC H02K 9/19

(57) ABSTRACT

A motor cooling system, includes a motor housing disposed with a motor built in the motor housing, a reservoir tank disposed in the motor housing and storing a cooling medium or supplying the cooling medium to an inside of the motor housing, a pump for pressurizing the cooling medium inside the motor housing and supplying the cooling medium to the reservoir tank or to the motor, to cool the motor, and a controller for supplying the cooling medium to the reservoir tank or supplying the cooling medium inside the reservoir tank to the motor housing based on a temperature of the motor or a temperature of the cooling medium inside the motor housing.

### CROSS REFERENCE TO RELATED APPLICATION

The present application claims priority to Korean Patent Application No. 10-2024-0165581, filed Nov. 19, 2024, the entire contents of which is incorporated herein for all purposes by this reference.

### BACKGROUND OF THE PRESENT DISCLOSURE

### Field of the Present Disclosure

The present disclosure relates to a motor cooling system.

### Description of Related Art

An electric vehicle (EV) is driven by a battery and a power electric (PE) system (a motor, an inverter, and a speed reducer). The battery and PE system include separate cooling systems to optimally drive the EV. The motor utilizes a water-cooling method in which the motor is directly cooled through spraying of a cooling medium.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a motor of a PE system built into a motor housing, and a cooling medium for cooling the motor may be stored in the motor housing. When a water level of the cooling medium inside the motor housing is high, the cooling efficiency of the motor is good, but due to the water level thereof being higher than required, drag loss (i.e., an energy loss due to resistance caused by the flow of the cooling medium) may occur, resulting in unnecessary power waste.

The present disclosure has been provided to solve such a problem, and an objective of the present disclosure is to provide a motor cooling system configured for varying water levels of a cooling medium in a motor housing.

The technical problems to be solved in the present disclosure are not limited to the technical problems mentioned above, and other technical problems that are not mentioned will be clearly understood by those skilled in the art to which the present disclosure pertains from the following description.

According to an exemplary embodiment of the present disclosure to achieve the above objective, there is provided a motor cooling system, including: a motor housing provided with a motor built in the motor housing; a reservoir tank disposed in the motor housing and storing a cooling medium or supplying the cooling medium to an inside of the motor housing; a pump configured for pressurizing the cooling medium inside the motor housing and supplying the cooling medium to the reservoir tank or to the motor, to cool the motor; and a controller configured for supplying the cooling medium to the reservoir tank or supplying the cooling medium inside the reservoir tank to the motor housing based on a temperature of the motor or a temperature of the cooling medium inside the motor housing.

According to an exemplary embodiment of the present disclosure, the reservoir tank may be disposed on the inside of the motor housing or on an outside of the motor housing.

According to the exemplary embodiment of the present disclosure, the reservoir tank may be disposed with an inlet/outlet unit for adjusting an inflow or an outflow of the cooling medium.

According to the exemplary embodiment of the present disclosure, the inlet/outlet unit may include: an inlet valve for adjusting the inflow of the cooling medium into the reservoir tank; and an outlet valve for adjusting the outflow of the cooling medium out of the reservoir tank.

According to the exemplary embodiment of the present disclosure, the controller may open the inlet valve and close the outlet valve based on that the temperature of the motor is less than or equal to a predetermined threshold value or the temperature of the cooling medium inside the motor housing is less than or equal to a predetermined reference value.

According to the exemplary embodiment of the present disclosure, the controller may close the inlet valve and open the outlet valve based on that the temperature of the motor exceeds a predetermined threshold value or the temperature of the cooling medium inside the motor housing exceeds a predetermined reference value.

According to the exemplary embodiment of the present disclosure, the inlet/outlet unit may include: an inlet valve for adjusting the inflow of the cooling medium into the reservoir tank; and a drain hole for draining the cooling medium introduced into the reservoir tank into the motor housing.

According to the exemplary embodiment of the present disclosure, the controller may open the inlet valve based on that the temperature of the motor is less than or equal to the predetermined threshold value or the temperature of the cooling medium inside the motor housing is less than or equal to the predetermined reference value.

According to the exemplary embodiment of the present disclosure, the controller may close the inlet valve based on that a temperature of the motor exceeds the predetermined threshold value or a temperature of the cooling medium inside the motor housing exceeds the predetermined reference value.

According to the exemplary embodiment of the present disclosure, the controller is configured to adjust a rotation speed of the pump based on the temperature of the motor or the temperature of the cooling medium inside the motor housing.

According to the exemplary embodiment of the present disclosure, the rotation speed of the pump may be proportional to the temperature of the motor or the temperature of the cooling medium inside the motor housing.

According to the exemplary embodiment of the present disclosure, the motor cooling system may further include a cooling flow path for supplying the cooling medium pressurized by the pump to the motor or to the reservoir tank.

According to the exemplary embodiment of the present disclosure, a cooler may be disposed between the pump and the reservoir tank, to cool the cooling medium.

According to the exemplary embodiment of the present disclosure, a speed reducer connected to a shaft of the motor may be disposed in the inside of the motor housing, and the pump may pressurize the cooling medium inside the motor housing and supply the pressurized cooling medium to the speed reducer, to cool the speed reducer.

According to the exemplary embodiment of the present disclosure, the motor cooling system may further include a cooling flow path for supplying the cooling medium pressurized by the pump to the motor, the speed reducer, or to the reservoir tank.

According to the motor cooling system of the present disclosure, the water level of the cooling medium inside the motor housing may be controlled based on the temperature of the motor or the temperature of the cooling medium inside the motor housing, optimizing the cooling performance of the motor and the electric vehicle power efficiency of EVs.

The effects of the present disclosure are not limited to the above-mentioned effects, and other different effects that are not mentioned will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view of a motor cooling system according to an exemplary embodiment of the present disclosure.

FIG. 2 is a block diagram of the motor cooling system according to the exemplary embodiment of the present disclosure.

FIG. 3 is a cross-sectional view (a cross-sectional view taken along line A-A in FIG. 1) of the motor cooling system according to the exemplary embodiment of the present disclosure.

FIG. 4 is a cross-sectional view (a cross-sectional view taken along line A-A in FIG. 1) of a motor cooling system according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

In describing an exemplary embodiment included in the present specification, when it is determined that a detailed description of a related known technology may obscure the subject matter of the exemplary embodiment included in the present specification, the detailed description thereof will be omitted. Furthermore, the accompanying drawings are only for easy understanding of the exemplary embodiment included in the present specification, so that the technical idea included in the present specification is not limited by the accompanying drawings, and it should be understood that the accompanying drawings include all changes, equivalents, or substitutes, which are included in the idea and technical scope of the present disclosure.

The present disclosure below is not intended to be limited to the specific forms or specific field described in the present disclosure, but is contemplated that various alternative aspects and modifications to the present disclosure may be made, whether expressly set forth or implied in the present specification. Those skilled in the art to which the present disclosure pertains will recognize that the forms and details of the content of the present disclosure may be modified.

The present disclosure is described with reference to specific aspects. However, as will be appreciated by those skilled in the art to which the present disclosure pertains, the various aspects included herein may be modified or implemented in various other ways without departing from the idea and scope of the present disclosure. Accordingly, the description below is to be considered illustrative and is intended to instruct those skilled in the art how to make and use various exemplary embodiments. It will be understood that the forms of the present disclosure illustrated and described herein are to be taken as representative exemplary embodiments. Equivalent elements or materials, and processes or steps may be substituted for those exemplified and described in the present disclosure. The words “including”, “comprising”, “incorporating”, “consisting of”, “have”, “is”, and the like, which are used in describing the present disclosure, should be construed in a non-exclusive manner, i.e., into a manner of also allowing items, components, or elements, which are not explicitly stated, to be displayed. In addition, references to the singular should be construed as including reference to the plural.

Furthermore, the various exemplary embodiments included in the present specification are to be taken in an exemplary and illustrative sense and should not be construed as limiting the content of the present disclosure. Any reference to joining (e.g., attached, affixed, coupled, connected, etc.) is only used to facilitate understanding of the present disclosure and does not form any limitation as to the location, orientation, or use of any component, or as to the method included in the present disclosure. Accordingly, in a case where joining references exist, they should be interpreted broadly. Moreover, such joining references do not imply that two or more elements are directly connected to each other. Additionally, any numeric terms, such as “first”, “second”, “third”, “primary”, “secondary”, “main”, or any other generic or numeric terms, are to be taken only as identifiers to aid in understanding the various components, forms, variations, or modifications of the present disclosure, and do not imply any limitation as to any component, form, variation, or modification or any order or preference with respect thereto. That is, these expressions may be used to describe various components, but the components are not limited by the corresponding expressions. The corresponding expressions are only used for distinguishing one component from another component.

The words “module” and “part/unit” used as compound words for the components used in the following descriptions are provided or mixed in consideration of only the ease of writing the specification, and the compound words do not have distinct meanings or roles by themselves.

It will be understood that when a component is referred to as being “coupled” or “coupled” to another component, it may be directly coupled or connected to the other component or intervening components may be present therebetween. In contrast, when a component is described as being “directly connected”, “directly coupled”, or “directly linked” to another component, it should be understood that there are no intervening component present therebetween.

Furthermore, a unit or control unit included in names is just a term widely used for naming of a controller that controls vehicle-specific functions, and does not mean a generic function unit.

The controller may include: a communication device for communicating with other controllers or sensors to control functions in charge; a memory for storing an operating system, logic instructions, and input/output information; one or more processors for performing determinations, calculations, decisions, etc., which are required for controlling the functions in charge; and the like.

Any number of components or a variety of components in any of the configurations described in the present specification may be included within the present disclosure described in the present specification. The components may include any combination of features described in the present specification and may be provided in any of the various configurations described in the present specification. The concepts of the structure and arrangement of the components of the present disclosure as well as their use and operation may be applied not only to the specific exemplary embodiments described in the present specification, but to any number of exemplary embodiments in any combination thereof. The exemplary embodiments including those including various features of various arrangements are described below with reference to the drawings.

Hereinafter, an exemplary embodiment included in the present specification will be described in detail with reference to the accompanying drawings, but regardless of the reference numerals, the same or similar components are provided the same reference numbers, and the overlapping description thereof will be omitted.

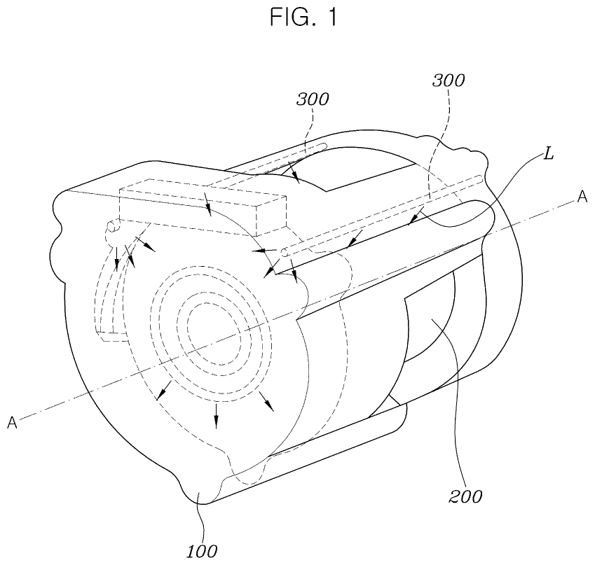

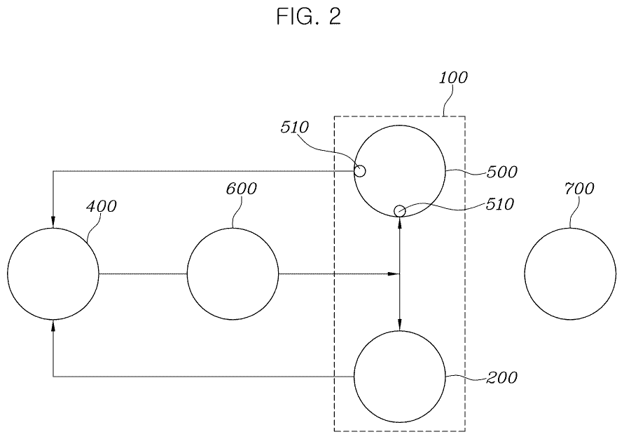

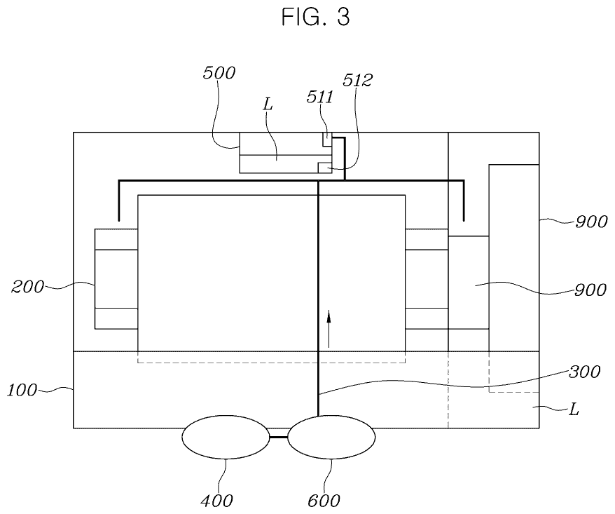

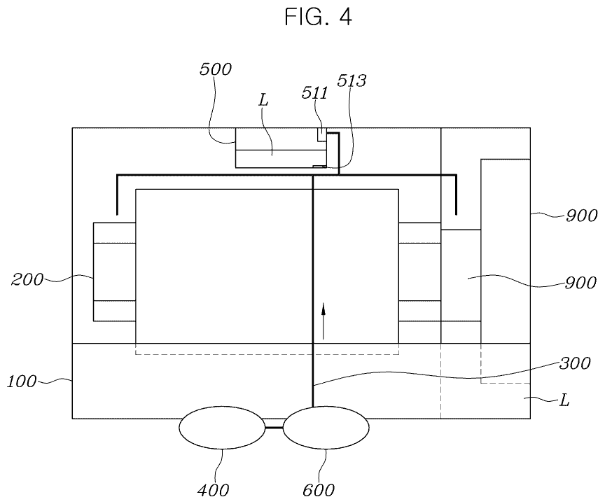

FIG. 1 is a side view of a motor cooling system according to an exemplary embodiment of the present disclosure, and FIG. 2 is a block diagram of the motor cooling system according to the exemplary embodiment of the present disclosure. FIG. 3 is a cross-sectional view (a cross-sectional view taken along line A-A in FIG. 1) of the motor cooling system according to the exemplary embodiment of the present disclosure. FIG. 4 is a cross-sectional view (a cross-sectional view taken along line A-A in FIG. 1) of a motor cooling system according to another exemplary embodiment of the present disclosure.

The motor cooling system according to an exemplary embodiment of the present disclosure may be used as a system for cooling a motor required for driving an EV. A motor 200 including a rotor and a stator is built into the inside of a motor housing 100, and a cooling medium L for cooling the motor 200 may be stored inside the motor housing 100 so that the cooling medium L is maintained at a water level greater than or equal to a minimum water level. The cooling medium L inside the motor housing 100 is connected to a pump 400 through a flow path or the like and supplied to the pump 400. The pump 400 may cool the motor 200 in a method of pressurizing the cooling medium L and spraying the cooling medium L onto the motor 200. The cooling medium L pressurized by the pump 400 is sprayed to the motor 200 through a cooling flow path 300, and is sprayed to a stator side coil of the motor 200 and a rotor of the motor, so that the motor 200 may be cooled. Furthermore, the cooling medium L that has finished cooling the motor 200 returns back into the motor housing 100.

According to a structure described above, the cooling medium L cools the motor while circulating through the motor housing, the pump, the motor and the motor housing in series in the present structure. Accordingly, the cooling medium L inside the motor housing 100 is maintained at a nearly constant water level.

As described above, when a water level of the cooling medium L in the motor housing 100 is high, the cooling efficiency of the motor 200 improves, but the electric vehicle power efficiency tends to decrease due to drag loss, so in a case where a temperature of the motor 200 is high, it is preferable to adjust the water level of the cooling medium L high, and in a case where a temperature of the motor 200 is low, it is preferable to adjust the water level of the cooling medium L relatively low.

To the present end, a reservoir tank 500 for storing a cooling medium L may be disposed in the motor housing 100. In addition to its function of storing the cooling medium L, the reservoir tank 500 may also perform a function of supplying the cooling medium L to the motor housing 100.

These functions may be performed by a controller 700. The controller 700 may supply the cooling medium L to the reservoir tank 500 based on a temperature of the motor 200 or a temperature of the cooling medium L inside the motor housing 100, to store the cooling medium L in the reservoir tank 500 or supply the cooling medium L inside the reservoir tank 500 to the motor housing 100.

That is, when a temperature of the motor 200 is determined to be high, the cooling medium L of the reservoir tank 500 is allowed to be supplied to the motor housing 100 to increase the cooling efficiency of the motor, and when a temperature of the motor 200 is determined to be low, the cooling medium L inside the motor housing 100 may be supplied to the reservoir tank 500 to suppress the occurrence of drag loss and increase the electric vehicle power efficiency.

Accordingly, the controller 700 may be connected to a motor temperature sensor and a cooling medium temperature sensor to detect a temperature change of the motor in real time and control the water level of the cooling medium L based on the detected temperature change.

The controller 700 is connected to the motor temperature sensor and able to directly measure the internal temperature of the motor. Data transmitted from the motor temperature sensor is used by the controller 700 to rapidly detect an overheating state of the motor and supply the cooling medium L to the motor 200 or recover the cooling medium L to the reservoir tank 500. The data obtained by measurement of the motor temperature sensor is analyzed in real time by the controller 700, and in a case of the motor 200 entering a high temperature state, the cooling medium L may be additionally supplied to the motor housing 100 immediately to maximally increase the cooling efficiency.

Furthermore, the controller 700 may be connected to the cooling medium temperature sensor to detect the temperature of the cooling medium L inside the motor housing 100. The cooling medium temperature sensor continuously measures the temperature of the cooling medium L inside the motor housing 100 and transmits the measured temperature to the controller 700, and in the present way, the controller 700 may monitor whether the cooling medium L is effectively absorbing heat or not.

As described above, the controller 700 may comprehensively analyze the data received from the motor temperature sensor and the cooling medium temperature sensor, to perform controlling the water level of the cooling medium L by considering both the temperature state of the motor and the heat absorption state of the cooling medium L.

Furthermore, the controller 700 may include a data map for water levels of the cooling medium inside the motor housing 100 according to the temperature of the motor 200 or the temperature of the cooling medium inside the motor housing 100. That is, the controller 700 may include the data map of which the input value is a temperature and the output value is a water level. The data map included in the controller 700 is configured in a form of a data table or a function that interrelates and records information on the temperature of the motor 200, the temperature of the cooling medium L, and the optimal water level of the corresponding cooling medium L. For example, the data map may be organized in a manner of setting a water level of the cooling medium to be kept high in a case where a motor temperature is high or in a case when a temperature of the cooling medium exceeds a set threshold value, and in contrast, may be organized in a manner of lowering a water level of the cooling medium when the motor is in a low temperature state to prevent drag loss.

Here, an oil-based cooling medium may be used as a cooling medium L. The oil-based cooling medium has electrically insulating properties, so that the oil-based cooling medium may be sprayed directly onto the motor to cool the motor, having high thermal stability to make it advantageous for long-term use.

In more detail, the reservoir tank 500 may be disposed on the inside or outside of the motor housing 100. The layout of the reservoir tank 500 may be flexibly changed depending on vehicle structures, designs, etc.

In a case where the reservoir tank 500 is disposed inside the motor housing 100, a movement path of the cooling medium L may be shortened, so that a supply time through the pump may be shortened. This enables efficient circulation of the cooling medium L when a rapid response to a sudden temperature change of the motor 200 is required, and thus it is advantageous to maintain the temperature of the motor 200 stably. Furthermore, in the case where the reservoir tank 500 is placed inside the motor housing 100, there is an advantage in that the reservoir tank 500 may be protected from external impact or environmental influences.

In contrast, in a case where the reservoir tank 500 is disposed on the outside of the motor housing 100, the maintenance and inspection of the motor cooling system become easier. The reservoir tank 500 placed externally is easily accessible when replenishment or replacement of the cooling medium L is required, and may save space inside the motor housing 100 to maximally reduce interference with the motor 200. Furthermore, the reservoir tank 500 placed on the outside of the motor housing 100 provides expandability that enables connection to an additional heat-exchange device, further increasing cooling efficiency.

The layout of the reservoir tank 500 may be selected by considering the temperature control requirements of the motor, structural constraints of an EV, and cooling efficiency. For example, in a case where a motor operates in an extremely high-temperature environment, an inside layout of the reservoir tank 500 may be chosen to prioritize cooling efficiency, whereas in a case where the EV has significant structural limitations or maintenance is important, an outside layout of the reservoir tank 500 may be chosen.

Accordingly, the exemplary embodiment of the present disclosure provides design flexibility that allows the selection of inside layout or outside layout for the reservoir tank 500, whereby an optimal motor cooling system may be configured according to various design requirements of EVs.

Furthermore, according to the exemplary embodiment of the present disclosure, an inlet/outlet unit 510 for controlling an inflow or an outflow of a cooling medium L may be disposed inside the reservoir tank 500. The inlet/outlet unit 510 is designed to control the flow of the cooling medium L to appropriately supply or recover a required amount of the cooling medium L depending on temperature changes of the motor 200. In the present way, the cooling medium L may be maintained at a constant water level and optimal cooling efficiency may be achieved in accordance with the temperature states of the motor 200.

The inlet/outlet unit 510 may be distinguished by an inlet for introducing the cooling medium L into the reservoir tank 500 and an outlet for supplying the cooling medium L to the motor housing. Both the inlet and outlet may be configured as a valve type. Alternatively, the inlet may be configured as a valve type and the outlet may be configured as a drain hole.

According to the exemplary embodiment of the present disclosure, the reservoir tank 500 may include: an inlet valve 511 for adjusting an inflow of the cooling medium L and an outlet valve 512 for adjusting an outflow of the cooling medium. These valves operate according to commands of the controller 700, and control the inflow and outflow according to the temperature of the motor 200 or the temperature of the cooling medium inside the motor housing 100.

In the exemplary embodiment of the present disclosure, depending on the temperature of the motor 200 or the temperature of the cooling medium L inside the motor housing 100, the inlet valve 511 and the outlet valve 512 may be operated as follows:

In a case where a temperature of the motor is less than or equal to a predetermined threshold value or a temperature of the cooling medium inside the motor housing is less than or equal to a predetermined reference value, the controller is configured to open the inlet valve to allow the cooling medium to flow into the reservoir tank, and simultaneously closes the outlet valve to prevent the cooling medium from leaking out of the reservoir tank.

In a case where a temperature of the motor exceeds the predetermined threshold value or a temperature of the cooling medium inside the motor housing exceeds the predetermined reference value, the controller is configured to close the inlet valve to block an additional cooling medium from flowing into the reservoir tank. At the same time, the controller is configured to open the outlet valve to allow the cooling medium inside the reservoir tank to flow out to the motor housing.

The predetermined threshold value corresponding to the temperature of the motor may be set higher than the predetermined reference value corresponding to the temperature of the cooling medium. Since the cooling medium is a component that cools the motor and absorbs some portions of heat from the motor but not all of it, the temperature of the cooling medium is generally set and kept to be lower than the temperature of the motor.

Since such a combination of the inlet valve 511 and the outlet valve 512 is automatically controlled by the controller 700, the amount of cooling medium L inside the motor housing 100 may be adjusted according to temperature changes.

When the EV is first driven, a temperature of the motor 200 and a temperature of the cooling medium L are relatively low, so that the controller 700 opens the inlet valve 511 and closes the outlet valve 512, to perform control in a direction where the cooling medium L is stored in the reservoir tank 500. This is to reduce energy consumption and optimize electric vehicle power efficiency by preventing unrequired circulation of the cooling medium in an initial state when cooling demand is not high.

When the EV is driven for a certain time period, the temperatures of the motor 200 and the cooling medium L gradually increase, and the controller 700 begins to appropriately adjust the water level of the cooling medium L in the motor housing 100 accordingly. For example, in a case where a temperature of the motor exceeds the predetermined threshold value or a temperature of the cooling medium exceeds the predetermined reference value, the controller 700 opens the outlet valve 512 and closes the inlet valve 511, to control the cooling medium L inside the reservoir tank 500 to be supplied to the motor housing 100. In the present way, the temperatures of the motor 200 and the cooling medium L may be rapidly lowered, maximally increasing the cooling efficiency.

Such a step-by-step control method may optimize and control the flow of the cooling medium according to the driving status and temperature conditions of the EV. Initially, the control method is operated in a manner in which the cooling medium L is stored in the reservoir tank 500 to prevent the drag loss, and then when the temperatures of the motor 200 and the cooling medium L rise, the cooling medium L flows into the motor housing 100 to maximally increase the cooling efficiency.

According to another exemplary embodiment of the present disclosure, an inlet/outlet unit 510 may include: an inlet valve 511 for adjusting an inflow of a cooling medium L into a reservoir tank 500; and a drain hole 513 for draining the cooling medium L introduced into the reservoir tank 500 into a motor housing 100. The drain hole 513 enables the cooling medium L to be supplied to the motor housing 100 at a constant rate, enabling stable and continuous cooling of a motor 200.

The inlet valve 511 is a valve that is configured to control a flow of the cooling medium L flowing into the reservoir tank 500, and is opened or closed by the controller 700 depending on the temperatures of the motor 200 and the cooling medium L. The inlet valve 511 adjusts the inflow of the cooling medium L into the reservoir tank 500, so that the cooling medium L is stored in the reservoir tank 500 only when required.

The drain hole 513 is a passage that continuously drains the cooling medium L from the reservoir tank 500 to the motor housing 100, to enable the cooling medium L stored in the reservoir tank 500 to be naturally supplied to the motor housing 100 by gravity. By adjusting the diameter of the drain hole 513, the amount of cooling medium L flowing from the reservoir tank 500 to the motor housing 100 may be controlled. Unlike the inlet valve 511, the drain hole 513 is not automatically opened or closed but always remains open to ensure continuous supply of cooling medium.

In the exemplary embodiment of the present disclosure, depending on the temperature of the motor or the temperature of the cooling medium inside the motor housing, the inlet valve may be operated as follows:

In a case where a temperature of the motor is less than or equal to a predetermined threshold value or a temperature of the cooling medium inside the motor housing is less than or equal to a predetermined reference value, the inlet valve 511 is opened to allow the cooling medium L to flow into the reservoir tank 500. Due to the provided configuration, as the cooling medium L accumulates in the reservoir tank 500, the excessive storage of the cooling medium L within the motor housing 100 in a condition of low cooling demand may be suppressed.

In a case where a temperature of the motor exceeds the predetermined threshold value or a temperature of the cooling medium inside the motor housing exceeds the predetermined reference value, the inlet valve 511 is closed to block an additional cooling medium L from flowing into the reservoir tank 500. In the instant case, the cooling medium L stored in the reservoir tank 500 flows out to the motor housing 100 through the drain hole 513, and the cooling medium L is continuously supplied into the motor housing 100, efficiently cooling the motor 200.

According to the exemplary embodiment of the present disclosure, in a case where the outlet valve 512 is changed to the drain hole 513, there is an advantage in that a structure of the motor cooling system is simplified. That is, unlike the outlet valve 512, the drain hole 513 does not require a valve opening/closing mechanism, so that the system structure becomes simpler. Since an additional control device or parts for opening and closing the valve are no longer required, the number and complexity of parts are reduced, whereby manufacturing cost reduction and design simplification may be simultaneously obtainable.

Furthermore, since the drain hole 513 functions as a path which is always open without a separate operating mechanism, it has an advantage of being easy to maintain because regular maintenance or replacement is not required as in the case of a valve.

Meanwhile, according to the exemplary embodiment of the present disclosure, the controller 700 may adjust a rotation speed of the pump 400 based on a temperature of the motor 200 or a temperature of the cooling medium L inside the motor housing 100. The rotation speed of the pump 400 is controlled to be proportional to the temperature of the motor 200 or the temperature of the cooling medium L. That is, in a case where a temperature of the motor 200 is high or in a case where a temperature of the cooling medium L increases to a temperature greater than or equal to a certain standard, the controller 700 increases the rotation speed of the pump 400 to increase a flow rate of the pressurized cooling medium L. In contrast, when the temperature decreases, the rotation speed of the pump 400 is reduced to adjust the cooling effect.

Furthermore, according to the exemplary embodiment of the present disclosure, a cooling flow path 300 for enabling the cooling medium L pressurized by the pump 400 to be supplied to the motor 200 or the reservoir tank 500 may be further included. The cooling flow path 300 is configured as a flow passage for the pressurized cooling medium L.

Furthermore, according to the exemplary embodiment of the present disclosure, a cooler 600 for lowering the temperature of the cooling medium L may be further disposed. The cooler 600 may be disposed between the pump 400 and the reservoir tank 500. Since the cooling medium L that cools the heated motor 200 is heated, the temperature of the cooling medium L is lowered by passing through the cooler 600 before the cooling medium L is supplied to the reservoir tank 500 or the motor 200 again, whereby the cooling medium L may be maintained at an appropriate temperature.

Meanwhile, according to the exemplary embodiment of the present disclosure, a speed reducer 900 connected to a shaft of the motor 200 may be disposed inside the motor housing 100. The speed reducer 900 serves an important role of converting an output speed of the motor, and may be configured to generate heat when operating at high speed (i.e., a speed higher than a predetermined speed). Since overheating of the speed reducer 900 may result in performance degradation and reduced durability, it is important to cool the speed reducer 900 properly. The speed reducer 900 is placed in a space divided within the motor housing 100, i.e., it is configured so that the speed reducer 900 is allowed to be positioned in the corresponding space. Due to the provided configuration, the cooling medium L may be maintained at a constant water level even in the specific space within the motor housing 100 where the speed reducer 900 is placed, enabling the efficient cooling of the speed reducer 900.

Accordingly, the pump 400 may pressurize the cooling medium L inside the motor housing 100 and supply the cooling medium L to the speed reducer 900, cooling the speed reducer 900. The pump 400 pressurizes the cooling medium L and supplies it to the speed reducer 900 inside the motor housing 100, so that heat generated during the operation of the speed reducer 900 may be efficiently removed. As the cooling medium L is continuously supplied to the speed reducer 900, the temperature of the reducer 900 is maintained stably, preventing performance degradation and damage due to the heat.

According to the exemplary embodiment of the present disclosure, the cooling flow path 300 may be branched to supply the cooling medium L not only to the motor 200 but also to the speed reducer 900 (INPUT, OUTPUT). Due to the provided configuration, the cooling medium L may be efficiently supplied to both the motor 200 and the reducer 900, effectively controlling the temperature of the entire motor cooling system.

The cooling flow path 300 may be designed in a structure where the cooling path 300 may be branched in the middle, and is disposed with one branch thereof for supplying the cooling medium L to the motor 200 and the other branch thereof for supplying the cooling medium L to the speed reducer 900. Through the present branch structure, the cooling medium L pressurized by the pump 400 may be supplied to the motor 200 and the speed reducer 900 simultaneously or separately as required.

The flow of the cooling medium L may be controlled according to the cooling requirements of the speed reducer 900 and motor 200 through the branch of the cooling flow path 300, so that the temperatures of the two components are maintained in a balanced manner. In the present way, efficient cooling of both of the motor 200 and the speed reducer 900 is enabled, preventing thermal overload or performance degradation.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory.

The memory and the processor may be individual chips. Alternatively, the memory and the processor may be integrated in a single chip. The processor may be implemented as one or more processors. The processor may include various logic circuits and operation circuits, may be configured for processing data according to a program disposed from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a predetermined condition is satisfied, to perform the related operation or interpret the related definition according to the predetermined condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A motor cooling system, comprising:
a motor housing provided with a motor built in the motor housing;
a reservoir tank disposed in the motor housing and storing a cooling medium or supplying the cooling medium to an inside of the motor housing;
a pump configured for pressurizing the cooling medium inside the motor housing and supplying the cooling medium to the reservoir tank or to the motor, to cool the motor; and
a controller electrically connected to the pump and configured for supplying the cooling medium to the reservoir tank or supplying the cooling medium inside the reservoir tank to the motor housing based on a temperature of the motor or a temperature of the cooling medium inside the motor housing.

2. The motor cooling system of claim 1, wherein the reservoir tank is disposed on the inside of the motor housing.

3. The motor cooling system of claim 1, wherein the reservoir tank is disposed on an outside of the motor housing.

4. The motor cooling system of claim 1, wherein the reservoir tank includes an inlet/outlet unit for adjusting an inflow or an outflow of the cooling medium.

5. The motor cooling system of claim 4, wherein the inlet/outlet unit includes:
an inlet valve for adjusting the inflow of the cooling medium into the reservoir tank; and
an outlet valve for adjusting the outflow of the cooling medium out of the reservoir tank.

6. The motor cooling system of claim 5, wherein the controller operatively connected to the inlet valve and the outlet valve is configured to open the inlet valve and to close the outlet valve based on that the temperature of the motor is less than or equal to a predetermined threshold value or the temperature of the cooling medium inside the motor housing is less than or equal to a predetermined reference value.

7. The motor cooling system of claim 5, wherein the predetermined threshold value is set higher than the predetermined reference value.

8. The motor cooling system of claim 5, wherein the controller is further configured to close the inlet valve and to open the outlet valve based on that the temperature of the motor exceeds a predetermined threshold value or the temperature of the cooling medium inside the motor housing exceeds a predetermined reference value.

9. The motor cooling system of claim 8, wherein the predetermined threshold value is set higher than the predetermined reference value.

10. The motor cooling system of claim 4, wherein the inlet/outlet unit includes:
an inlet valve for adjusting the inflow of the cooling medium into the reservoir tank; and
a drain hole for draining the cooling medium introduced into the reservoir tank into the motor housing.

11. The motor cooling system of claim 8, wherein the controller is further configured to open the inlet valve based on that the temperature of the motor is less than or equal to a predetermined threshold value or the temperature of the cooling medium inside the motor housing is less than or equal to a predetermined reference value.

12. The motor cooling system of claim 11, wherein the predetermined threshold value is set higher than the predetermined reference value.

13. The motor cooling system of claim 8, wherein the controller is further configured to close the inlet valve based on that the temperature of the motor exceeds a predetermined threshold value or the temperature of the cooling medium inside the motor housing exceeds a predetermined reference value.

14. The motor cooling system of claim 1, wherein the controller is further configured to adjust a rotation speed of the pump based on the temperature of the motor or the temperature of the cooling medium inside the motor housing.

15. The motor cooling system of claim 14, wherein the rotation speed of the pump is proportional to the temperature of the motor or the temperature of the cooling medium inside the motor housing.

16. The motor cooling system of claim 1, further including:
a cooling flow path connected to the pump and supplying the cooling medium pressurized by the pump to the motor or to the reservoir tank.

17. The motor cooling system of claim 1, wherein a cooler is connected between the pump and the reservoir tank, to cool the cooling medium.

18. The motor cooling system of claim 1,
wherein a speed reducer connected to a shaft of the motor is disposed in the inside of the motor housing, and
wherein the pump pressurizes the cooling medium inside the motor housing and supplies the pressurized cooling medium to the speed reducer, to cool the speed reducer.

19. The motor cooling system of claim 18, further including:
a cooling flow path connected to the pump and supplying the cooling medium pressurized by the pump to the motor, the speed reducer, or to the reservoir tank.

20. A vehicle of the motor cooling system of claim 1.
